(19) United States
(12) Patent Application Publication
(10) Pub. No.: US 2024/0033820 A1
(43) Pub. Date: Feb. 1, 2024

(54) Method and System for Processing a Powder Material for Additive Production of a Workpiece

(71) Applicant: PRO-BEAM GMBH & CO. KGAA, Gilching (DE)

(72) Inventors: Thorsten LOWER, Munich (DE); Alexander KLASSEN, Munich (DE); Johann TEWES, Krailling-Pentenried (DE); Sebastian POHL, Munich (DE)

(21) Appl. No.: 17/998,550

(22) PCT Filed: May 7, 2021
(86) PCT No.: PCT/EP2021/062134

§ 371 Date: May 10, 2023

(30) Foreign Application Priority Data
May 11, 2020 (DE) 10 2020 112 719.7

(51) Int. Cl. B22F 1/142

(52) U.S. Cl. CPC B22F 1/142; B33Y 40/10

(57) ABSTRACT

A method of processing a powdery material for additively manufacturing a workpiece (22) comprises the steps of: (a) providing a device (15) for receiving a powder bed (20) of the powdery material to be machined and a beam generator (12) adapted to direct an energy beam (13) to laterally different locations of the powder bed (20); b) applying the powdery material in layers to the powder bed (20); c) irradiating an area (30; 30a; 30b; 30c) in the powder bed (20) with the energy beam (13), wherein the area (30; 30a; 30b; 30c) is composed of a plurality n of points P1 . . . Pn arranged in two dimensions, which are irradiated one after the other. In order to improve the scanning strategy during step c), it is provided that at least once during the irradiation of the area two successively irradiated points Pi, Pi+1 are spaced apart from each other in such a way that in each of the two dimensions at least one other point P1 . . . Pi−1, Pi+2 . . . Pn to be irradiated is located between the two successively irradiated points Pi, Pi+1.

### BACKGROUND OF THE INVENTION

### 1. Field of the Invention

The invention relates to a method for processing a powdery material for additive manufacturing of a workpiece. In particular, the invention relates to a method for preheating the powdery material and a method for melting the powdery material.

The invention further relates to a system for carrying out such methods for processing powdery material.

### 2. Description of the Prior Art

Additive manufacturing processes such as 3D printing are characterized by joining volume elements to form a workpiece with a three-dimensional structure, in particular by a layer-by-layer structure. Among other things, methods are used in which an energy beam is used to join a powdery material in a powder bed by selectively melting together the individual powder particles of the material point by point and layer by layer to form a solid 3D structure. The material can be solidified by sintering, i.e. only partial melting, or complete melting of the powder particles by means of laser beams or electron beams and subsequent solidification. In the following, the term melting will be understood to mean both variants.

The processing of powdery material, in particular metal powder, by selective melting with an electron beam (Selective Electron Beam Melting; SEBM) or with a laser (Selective Laser Melting; SLM) allows the production of complex geometries and structures with fast and precise manipulability and a high degree of automation.

However, complex geometries also pose great challenges to process control, which cannot be met in some cases by the familiar scanning strategies used to guide the energy beam laterally across the powder bed.

Common scanning strategies are based on guiding the energy beam along parallel paths. Asymmetries in the shape of the workpiece, such as corners or tapers, are not energetically taken into account. This leads to accumulation of heat and/or charge carriers in certain fields of the workpiece and consequently to unwanted changes in the process conditions or material properties, so that the quality of the workpieces produced can suffer. This is because in both laser and electron beam processes, large temperature gradients during production lead to distortion phenomena and residual stresses in the finished workpieces. If, on the other hand, the process conditions or material properties are monitored, this leads to frequent process interruptions.

In the case of selective melting with an electron beam (SEBM), there is a further problem: The processing of the powdery material with the electron beam causes a locally and temporally limited electrostatic charge of the irradiated powder bed due to the impacting electrons, since metal powder particles, for example, are often surrounded by an oxide layer, which is less conductive. Therefore, even a metal powder particle, although conductive in its interior, can become electrically charged when the electron beam strikes it.

The charging can reach a supercritical level and collectively accelerate the powder particles resting in the electron beam impingement area out of the processing zone, i.e. distribute them from the powder bed to other areas of the electron beam system, before the fusion process occurs. This leads to material loss and process interruptions, as the material is expelled from the powder bed before a sufficient degree of sintering is reached.

In order to avoid malfunctions and material loss due to powder expulsion, it is known according to the current state of the art, after a layer of the powdery material has been applied, to preheat it in a preheating step by irradiation with lower energy, in particular lower electron current, along parallel paths, in order to bond the individual powder particles together with lower adhesion compared to the end product.

Only in a second step, the melting step, are the powder particles then laterally selectively melted in the respective contour layer of the 3D structure to be generated with the electron beam to such an extent that a sufficient stability of the 3D structure is produced between the individual powder particles for the subsequent intended use of the workpiece.

Also in the melting step, the energy beam—regardless of whether a laser beam or an electron beam is used—is directed along parallel paths onto the uppermost powder layer and a melt pool is generated, which then moves linearly in accordance with the irradiation pattern.

Many disadvantages of known methods can be attributed to inhomogeneous temperature fields, which in turn depend on the scanning strategy.

### SUMMARY OF THE INVENTION

It is therefore the task of the invention to disclose a method for processing a powdery material for additive manufacturing of a workpiece, which is improved with respect to the scanning strategy. Preferably, this can also reduce inhomogeneities of the workpiece. It is further the task of the invention to disclose a corresponding system for processing the powdery material.

The task according to the invention is solved by a method for processing a powdery material for additive manufacturing of a workpiece comprising the following steps:
a) providing
   a device for receiving a powder bed of the powdery material to be processed and
   a beam generator adapted to direct an energy beam to laterally different locations of the powder bed;
b) applying the powdery material in layers to the powder bed;
c) irradiating an area in the powder bed with the energy beam, the area being composed of a plurality n of points P1 . . . Pn arranged in two dimensions, which are irradiated successively;
characterized in that
d) at least once during the irradiation of the area, two successively irradiated points Pi, Pi+1 are spaced apart from each other in such a way that in each of the two dimensions at least one other point P1 . . . Pn to be irradiated is located between the two successively irradiated points Pi, Pi+1.

The inventors have recognized that in known powder processing operations, the energy beam is usually directed onto the powder surface along paths parallel to each other (see FIG. 2a). The inventors have further recognized that this causes the energy input to be highly concentrated around the point being processed. By irradiating one point on the powder surface, the energy is indeed transferred to neighbouring regions by thermal conduction. However, very many methods take place in a vacuum and under negative pressure, so that the heat transfer is mainly limited to the powder. With linear irradiation, on the other hand, additional energy is introduced into regions that have already been heated, and thus local heat points are generated, since the heat conduction in the molten bath is more pronounced there. In order to avoid effects such as powder expulsion and uncontrolled melting, known methods therefore often work with periods of no or very low energy input, thus extending the process time.

The method according to the invention solves the described problem of inhomogeneous temperature distribution in that the energy is introduced in a distributed pointwise manner, thus avoiding local heat and charge accumulations. For this purpose, the points to be irradiated within an area are irradiated successively in such a way that on a grid of the points to be irradiated, points which are not directly adjacent are irradiated successively at least once, preferably more than 20 times. The points of the area are not irradiated directly one after another within their grid row by row and line by line. Instead, points of the raster are initially omitted in both dimensions, which are then irradiated in the later course of the irradiation scan.

The mentioned distance for two successively irradiated points, according to which at least once in both dimensions at least one other point P1 . . . Pn to be irradiated should lie between the two successively irradiated points Pi, Pi+1, is to be regarded as the absolute lowest limit compared to previous scanning strategies. Of course, the advantages of the are better realized the larger the distances between two successively irradiated points within the area are chosen.

Preferably, therefore, step d) comprises at least more than 10 times, preferably more than 20 times, preferably more than 50 times, that between the two successively irradiated points Pi, Pi+1 in both dimensions of the grid formed by the points located in total in the area to be irradiated there are at least 1, preferably at least 5, preferably at least 10, preferably at least 20 points. In the two dimensions of the grid, there can also be a different number of initially omitted points to be irradiated, for example at least 5 in an x-direction and at least 10 in a y-direction.

In this way, the area to be irradiated can be heated more uniformly. This is because the thermal energy introduced has more time to distribute into the surroundings of the respective irradiated point due to the irradiation jumping back and forth in a pointwise manner, without locally excessive energy input due to directly adjacent irradiation.

A point or spot according to the invention is considered to be a location that is irradiated by the energy beam without it being actively moved by deflection coils, movement of the coordinate table or similar devices.

A finite number of possible points is determined in the area of the powder bed to be irradiated. Preferred boundary conditions for the distribution of the points to be irradiated are, for example, to irradiate each point of the area at least once or to irradiate each point exactly once.

Preferably, it is provided that at least 10%, preferably at least 30%, again preferably at least 60%, of the distances of two successively irradiated points Pi, Pi+1 differ from those distances of the subsequently successively irradiated points Pi+1, Pi+2 from each other.

If the distances between two of three successively irradiated points Pi, Pi+1 and Pi+2 differ from each other, an irregularity is introduced into the irradiation step, which additionally prevents locally concentrated energy excesses from forming within the area to be irradiated. Thereby, a different distance can differ from the previous distance in only one dimension but also in both dimensions. Above all, however, the amount of the following distance can differ from the previous distance by more than 10%, preferably more than 30%, again preferably more than 60%.

Of course, a wide variety of algorithms for selecting the points are conceivable for such point-wise spaced irradiation. These can, but do not necessarily have to, also take into account the shape of the area to be irradiated.

Preferably, however, the selection of the next point Pi+1 to be irradiated in step c) is random, pseudo-random or quasi-random.

By randomly, pseudo-randomly or quasi-randomly selecting the points to be successively irradiated from the totality of the points to be irradiated in the area (hereinafter also abbreviated as stochastic irradiation), the above-mentioned spacing of at least some of the successive points is automatically obtained. The pointwise irradiation of the powder surface, where the selection of the next point is done with a random component, thus allows a more uniform distribution of the energy input, without the need to follow a specific distribution plan in advance.

The starting point of the irradiation can be any point within the area of the powder bed to be irradiated. The decision of the next point to be irradiated then includes a random component. This random selection can be random in the classical sense, but it can also be only pseudo-random or quasi-random using a random number generator or similar function.

The basis for the selection and sequence of the points to be irradiated can thus also be one of the known quasi-random or pseudorandom sequences, e.g. Mersenne twister, permuted congruence generator, multiply-with-carry, Fibonacci generator, arithmetic random number generators, Well Equidistributed Long-period Linear, XOR-shift, block or stream ciphers, cryptological hash functions, van der Corput sequences, additive recurrence, Halton sequence, Hammersley set, Sobol sequence, Faure sequence, Niederreiter sequence, Poisson disk sampling, and/or similar deterministic low-discrepancy sequences.

A quasi-random point sequence also has the advantage that here the density distribution of the successively irradiated points is more uniform and this evolves more evenly than in a random or pseudo-random sequence.

Preferably, step c) is provided to be part of a heating step in which an energy input introduced by the energy beam into the powder bed is not sufficient to completely melt the powdery material.

As already explained, heating steps which only lead to a temperature increase insufficient for a complete melting process are known from the prior art. Since such heating steps are usually used over a larger area and are not locally specific, the spaced irradiation strategy according to the invention is particularly suitable for them.

In one embodiment of the invention, spaced irradiation with an energy beam is applied in a preheating step. This causes a homogeneous thermal and (in the case of SEBM) electric field in the preheating step. Especially in the case of preheating with an electron beam, this significantly increases process stability. Preheating with spaced irradiation prevents charge accumulation and thus reduces the tendency for electrostatic powder expulsion.

The heating step can be a preheating step, an intermediate heating step, and/or a postheating step.

In this context, a preheating step is understood to be any process step in which the still powdery material is prepared for the actual melting process with higher energy input by lower energy input (shorter irradiation time in one point or lower beam energy), in particular in such a way that the powdery material does not yet solidify into a final workpiece due to the energy input of the preheating step.

If necessary, it may be necessary to reheat the temperature of the powder bed after a preheating step and after parts of the area have already been melted, due to the time required for the melting step, before further parts of the area are melted. This is understood as an intermediate heating step.

A post-heating step is understood to be any process step in which the actual workpiece is subjected to controlled tempering after solidification, if necessary, by applying energy to certain partial areas or the total area of a layer.

Preferably, it is provided that the heating step comprises a 2-stage heating process.

The heating step may be a multi-stage process. In the first stage, energy is introduced over a large area with an energy beam to achieve or maintain the desired build temperature. In a second stage, geometrically specific sintering is performed in order to locally sinter more strongly in subsequent melting areas and to mechanically remove overhangs and to mechanically support overhangs or structures on loose powder. Especially for large areas, a multi-stage heating process can prevent temperature fluctuations due to local cooling. The second stage can follow directly after the first stage, be carried out in parallel with melting, and/or be carried out after melting before a new layer of powder is applied. In particular, the two-dimensional preheating step can be performed with stochastic irradiation or by means of classical raster scanning along paths.

By only localized preheating, in particular only locally enhanced sintering, a higher degree of powder recycling can be achieved and the free blasting or unpacking of the finished workpiece can be facilitated.

Preferably, step c) is provided to generate a molten bath, and preferably the generated molten bath is not guided.

In another embodiment of the invention, the spaced irradiation is used to melt the powdery material. The controlled thermal field during melting prevents local alloy changes by avoiding temperature peaks. Material properties can be improved or controlled as needed by changing the microstructure. The microstructure is substantially responsible for the material properties of the workpiece and influences characteristic values such as hardness, strength and modulus of elasticity. Smaller self-contained melt pools can have a higher solidification rate and, as a result, different phase characteristics and/or a finer microstructure.

By controlling the energy input, pores, surface unevenness and deviations in the workpiece properties can therefore be avoided. Another advantage is the geometry independence of the randomized irradiation pattern. Large and small cross sections can be equally covered with stochastic irradiation and inhomogeneities due to cross section variations are avoided.

Preferably, it is provided that the generated melt pool is not guided.

In pointwise statistical melting, melt pools are created that are not guided, i.e., there is no lateral movement of the center of the melt. This allows easier control of the hydrodynamics of the melt pool, since the lack of lateral movement avoids material transport along the melt track.

The melting process may be preceded or superimposed by a single- or multi-stage heating process with an energy beam. The latter can be accomplished, for example, by a rapid alternation between pointwise melting and two-dimensional preheating.

In further embodiments, additional conditions may be present for selecting the next point, e.g., a certain radius around the previously irradiated point may not be irradiated. Also, a scan control algorithm may take into account the strength of the energy input at a point to be irradiated or how often a given energy input should occur. For example, a stronger irradiation can be generated at the edges of the area to be irradiated, or an uneven irradiation can be generated based on an energy model, etc.

If two successively irradiated points are placed too close to each other, the two resulting melt pools will combine with each other and mass transport will take place between the melt pools. This causes disadvantages for the workpiece properties such as alloy changes, irregularities and a coarser microstructure. Therefore, a local minimum distance between two successively irradiated points can be defined. Preferably, two successively irradiated points Pi, Pi+1 are spaced apart in such a way that in both dimensions at least two other points P1 . . . Pi−1, Pi+2 . . . Pn to be irradiated are located between the two successively irradiated points Pi, Pi+1.

Therefore, a minimum time distance around an irradiated point can also be defined. Depending on the ambient and irradiation parameters, a molten pool needs several milliseconds to solidify completely or at least partially. During this time, no point within the local minimum distance should be irradiated. I.e. points to be irradiated, which are successors and or even later successors in the irradiation sequence, are subjected to a secondary condition, according to which they must not fall within the minimum distance of the predecessor and so on. The temporal minimum distance defines for how many successors this constraint is to be applied.

Additionally, a local maximum distance to the next point can be defined. Smaller jump distances of the beam result in more uniform melt pools and a more homogeneous surface structure. A local maximum distance can be implemented by a superimposing function or by dividing the area to be irradiated into sub-areas or cells. These sub-areas or cells can then be irradiated completely or to a certain percentage in such a way that first the points to be irradiated in one of the sub-areas or cells are irradiated according to the method of the invention before another sub-area or cell is irradiated.

In a preferred embodiment of the method according to the invention, the random function is superimposed with an energy-dependent function.

By means of an underlying energy-dependent model, among other things, the energy and/or the temperature can be taken into account by considering local conditions as well as the position of already irradiated points, also in previous powder layers, and their residual energy. This enables a demand-based control of the energy input and a better adjustment of the microstructure over the entire workpiece. In addition, energy-dependent statistical irradiation can be used to adjust the microstructure variably within the workpiece.

In order to realize a demand-oriented control of the energy input, a model of the workpiece to be produced is created in order to be able to query the energy state in spatial and temporal dependence. The model is used to identify regions to which energy is to be applied. A precisely coordinated amount of energy is then randomly introduced into these specific regions with the energy beam.

The energetic model includes, in particular, data on the electric field, the thermal field, the geometry of the workpiece, the geometry of the build space and/or material compositions of the powder bed, the gas space and the pressure in the process chamber. In an active layer, the position of the previous points can be taken into account, the distance from each other considering the anticipated heat transfer, as well as the layer thickness of the powdery material. The energetic effects of the previous layer can also be taken into account and heat transfer from the area melted in the previous layer into the new powder layer can be included.

In addition to the position of the melted points, beam parameters can also be adjusted, in particular the dwell time, lens current and/or beam strength can be changed. The parameters can also be adjusted variably per point, e.g. with a ramp.

Superposition effects of heat and material can be specifically exploited by the adapted energy input and the demand-based control. Temperature peaks and significant material loss due to evaporation can be avoided and the original chemical composition can be maintained.

Preferably, it is provided that wherein the selection of the next point to be irradiated is random, pseudo-random or quasi-random as well as dependent on the energy input, in particular an energy balance or a heat balance.

The sequence of points to be irradiated and/or the corresponding beam parameters can be calculated and determined before the start of the build or during the build, in particular before each new powder layer to be irradiated or point by point while a current point is being irradiated. In this way, measured real-time data can also be included.

Preferably, it is provided that the path between two points to be irradiated Pi, Pi+1 is exposed.

In order to approach the calculated points to be irradiated with the beam, the beam needs a certain time to cover the path between the points. This time depends on the beam technology used. Electron beams can be deflected on the order of 1°/μs, lasers take much longer due to the inertia of deflection mirrors. In the method according to the invention, the path between the points to be irradiated can also be exposed. In general, a continuously switched-on energy beam is preferred over a pulsed energy beam because of a static state that sets in.

The time between points can be predetermined, kept as short as possible depending on the path length that must be travelled, or a combination of these can be chosen. However, the time that each point is irradiated along the path length is significantly less than the randomly determined points at which the beam is held. As a consequence, the energy input at the stopping points is significantly larger. For this reason, we will speak here only of exposing the path, in order to emphasize linguistically the difference between a point of the area to be deliberately irradiated and intermediate spaces that are only briefly swept.

The path length between the points can be kept as short as possible, be freely selectable within a certain time limit and/or have a certain geometric form, in particular a circular arc. The path length and/or time can be selected extra independently for each point, e.g. alternating between shortest path and arc-shaped path. In order to avoid energy accumulations in the center of the area of the uppermost powder layer to be irradiated due to multiple crossing paths, the path between the points can be adjusted so that the same amount of energy is also introduced in the peripheral areas of the cross-section.

Preferably, the energy beam is an electron beam.

In a preferred embodiment of the invention, the powdery material is processed under vacuum or negative pressure and is a method without auxiliary gases. Preferably, no additional gases such as helium are introduced into the process chamber. Due to the homogeneous, thermal and electric field generated in the method according to the invention, it is not necessary to provide for additional stabilization of the process by introduced gases. As a result, the disadvantages associated with auxiliary gases in the process chamber, such as beam expansion, additional costs at the plant as well as in operation, and additional contamination, can be avoided.

Preferably, the accelerating voltage in the method according to the invention is 90 kV to 150 kV, in particular 100 kV or greater, preferably 120 kV or greater.

Preferably, the beam power is at least 100 W and at most 100 kW.

Preferably, the powdery material comprises titanium, copper, nickel, aluminium and/or alloys thereof, in particular Ti-6Al-4V, an alloy comprising titanium, 6 wt % aluminium, and 4 wt % vanadium.

Preferably, the powdery material has an average grain size D50 of 10 μm to 150 μm.

With respect to the apparatus for processing powdery material with an electron beam apparatus, the apparatus according to the invention comprises a device for receiving a powder bed of the powdery material to be processed, and a beam generator adapted to direct an energy beam to laterally different locations of the powder bed, the apparatus being adapted to carry out the methods according to the invention.

Workpieces produced by the methods according to the invention as well as by the equipment according to the invention are used, among other things, in the aerospace industry as turbine blades, pump wheels, and transmission mounts in helicopters; in the automotive industry as turbocharger wheels as well as wheel spokes; in medical technology as orthopaedic implants and prostheses; as heat exchangers; and in tool and die making.

### BRIEF DESCRIPTION OF THE DRAWINGS

In the following, embodiments of the invention are explained in more detail with reference to the drawings. These show:

FIG. 1: a schematic view of a system according to the invention with a powder container;

FIG. 2: a schematic representation of different irradiation strategies;

FIG. 3: a schematic representation for creating a randomized sequence of points;

FIG. 4: a schematic representation of a preheating step with stochastic irradiation;

FIG. 5: a schematic representation of a melting step with stochastic irradiation;

FIG. 6: a schematic representation of a multi-stage preheating step with stochastic irradiation;

FIG. 7: a schematic representation of a stochastic irradiation with deliberate increase or decrease of the energy input in certain areas;

FIG. 8: a schematic representation of an irradiation with a subdivision of the area to be irradiated into smaller cells;

FIG. 9 a schematic representation of an irradiation with a further subdivision of the cells according to FIG. 8 into subcells.

### DESCRIPTION OF PREFERRED EMBODIMENTS

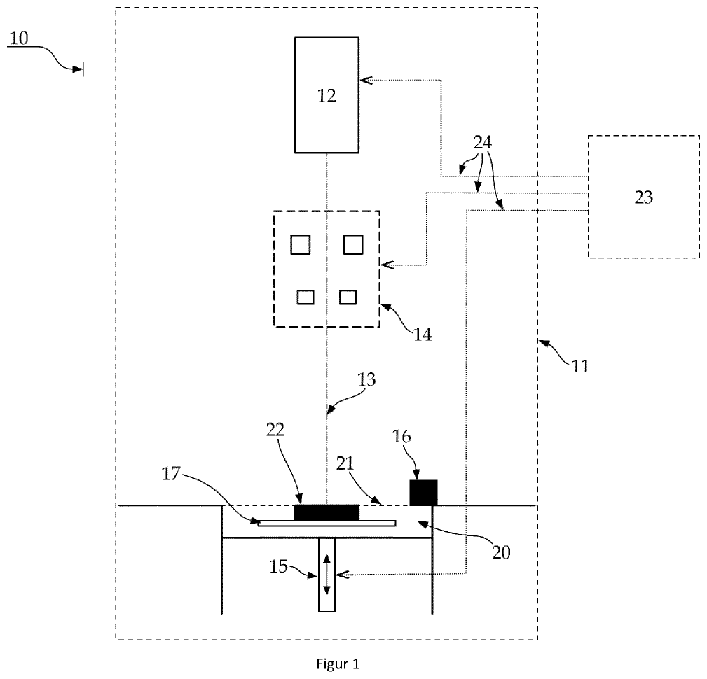

FIG. 1 shows an electron beam system 10 with a process chamber 11 in which an electron beam generator 12 for generating an electron beam 13 is arranged.

In the present embodiment, the electron beam generator 12 with an optional deflection device 14, for example a magnetoptical unit, is arranged above a lifting table 15 with a lifting plate and with a receiving frame, which serves as a spatially limited powder container, which receives a powder bed 20 of a powdery material to be processed.

Above the receiving frame, a powder application device 16 with a doctor blade (not shown) is arranged, which can be moved over the lifting table. The powder application device 16 has a container for the powdery material, which is not shown, from which the material can be evenly applied to the powder bed 21 by a traversing movement in each case as the uppermost loose layer 21.

The relative movement of the electron beam to the powder bed 20 can be achieved by deflection of the electron beam in the deflection device 14, or by displacement of the lifting table.

Furthermore, a base plate 17 is located in the powder bed 20, on which the workpiece 22 is formed layer by layer.

A control unit 23 is connected via one or more signal transmission lines to the essential components of the electron beam system 10, in particular to the electron beam generator 23 and the magneto-optical unit 14, in order to control the entire manufacturing process.

Further systems according to the invention include laser beam systems in vacuum, in atmosphere, overpressure as well as with auxiliary gases.

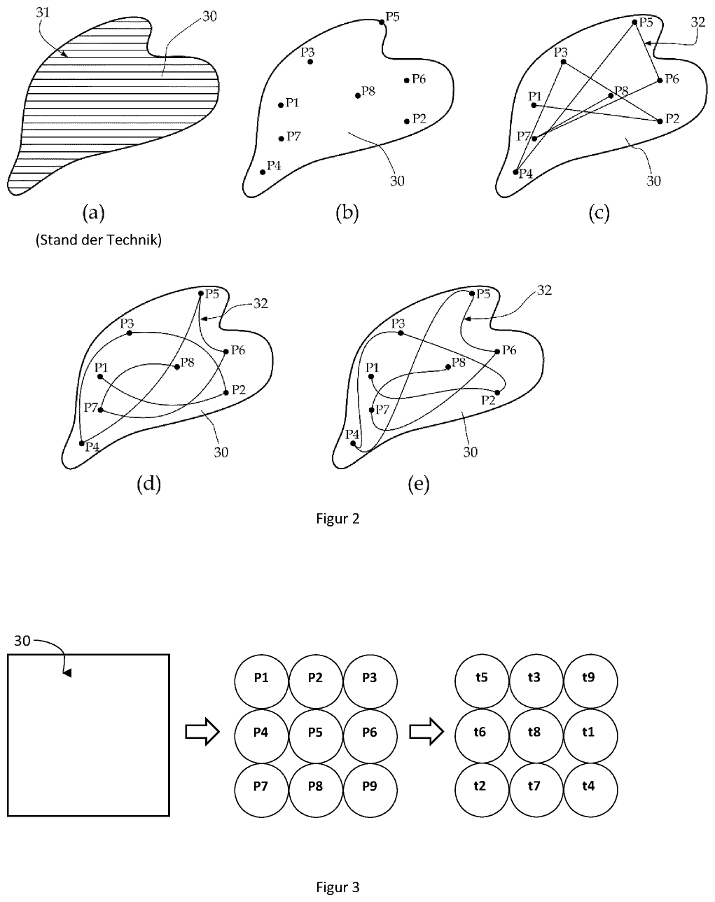

FIG. 2 shows different strategies for irradiating the powdery material in the powder bed 20.

FIG. 2a shows an irradiation strategy according to the current state of the art. Here, linear scanning is performed within the irradiation area 30. That is, in the melting step, the beam and thus the melt pool is guided along the parallel paths 31 outlined in FIG. 2a. In the process, material is transported along the path and energy is introduced very densely. The heat accumulation due to the locally centered energy input leads to disadvantages in both the preheating step and the melting step, such as expulsion of the powder and resulting process interruptions, as well as defects in the workpiece due to uneven energy input.

FIGS. 2b, 2c, 2d, 2e show irradiation strategies according to the invention.

FIG. 2b shows a stochastically distributed point irradiation. The location of the next point to be irradiated is randomly selected and can be at any point on the previously defined irradiation area. The energy beam is directed to the defined point for a specified time and then continues to jump to the next point to be irradiated.

In further embodiments, additional conditions may be present for selecting the next point, e.g., a certain radius (minimum distance) around the previously irradiated point may not be irradiated in the next step of the point sequence, stronger irradiations at the edges of the area based on an energy model, etc.

FIGS. 2c, 2d and 2e show embodiments of the invention in which stochastically distributed points are irradiated for a certain time, as shown in 2b, and the paths between the points are also irradiated.

In FIG. 2c, the shortest path between two points to be irradiated is chosen for this purpose. For this purpose, a point is irradiated for a certain time with certain beam parameters, then the beam is directed to the next point to be irradiated. This can be within the smallest technically possible time, i.e. within a few microseconds, within a predetermined time or at a certain speed. The energy input varies due to the variable speed and irradiation time, but the energy input is significantly higher at the points to be irradiated.

In the embodiment shown in FIG. 2d, an arc-shaped path is chosen instead of the shortest path. This opens up the possibility of influencing the energy distribution within the irradiation area in addition to the position of the stop points, and of placing the paths at less irradiated regions, in particular edge regions.

In FIG. 2e an example is sketched, in which the path between the points is freely selectable and is given only by time and/or speed. The choice of the path can also be random, or based on an energy model.

FIG. 3 shows a schematic diagram for creating a randomized sequence of points according to one embodiment of the invention.

The area 30 to be irradiated is converted into a point set P1-P9 by a discretization algorithm. The set of points P1-P9 includes all points to be fused in order to fuse the entire area 30. In FIG. 3, the point set P1-P9 is represented by circular areas. This point set P1-P9 is transferred into a point sequence A. A point sequence B is generated from this point sequence A by permutation.
A={P1, P2, P3, P4, P5, P6, P7, P8, P9}
B={P5, P3, P9, P6, P8, P1, P2, P7, P4}

The order of the points in the sequence of points B, gives the order of the points to be successively melted. Thus, for each point, there is a time as shown in the table below:

$$\begin{matrix}Point & P 1 & P 2 & P 3 & P 4 & P 5 & P 6 & P 7 & P 8 & P 9 \\ Time & t 5 & t 3 & t 9 & t 6 & t 8 & t 1 & t 2 & t 7 & t 4\end{matrix}$$

In particular, a random permutation of the first sequence of points A into the second sequence of points B can be achieved as follows:
1. a random number between 0 and 1 is created by a random number generator.
2. this random number is multiplied by the number of elements in the first sequence and rounded up.
3. the point from the first sequence, which is in the place of the multiplied number, is appended to the second sequence and removed from the first sequence.
4. steps 1.-3. are repeated until the first sequence is empty.

Particularly advantageously, the scanning strategy according to the invention can be used to guide the energy beam during a preheating step.

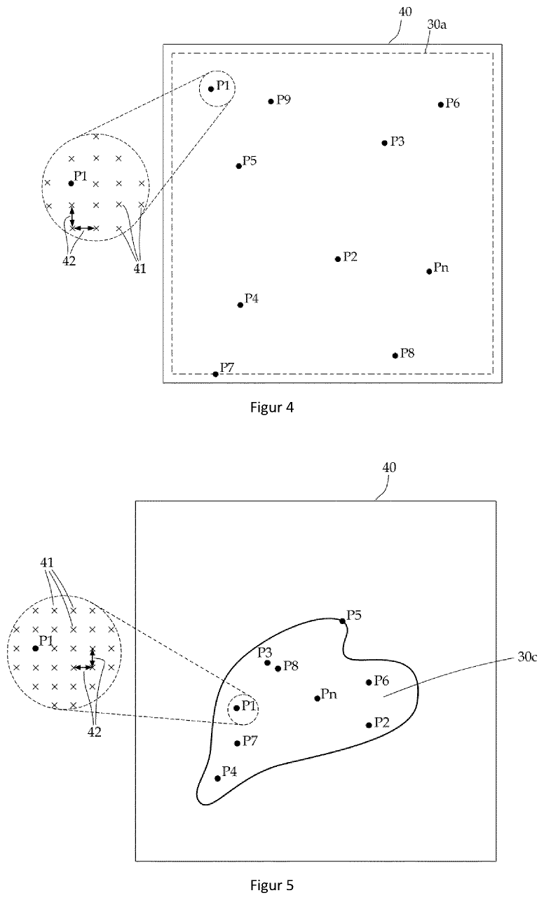

FIG. 4 schematically shows a heating area 30a, within which a powder bed is heated by means of energy input via an energy beam, as an example. The heating area 30a can be of any shape and size; in the present embodiment, it is square and lies entirely within the deflection field 40 of the one energy beam. Within the heating area 30a, the energy beam is guided over a defined number of stopping points P1 to Pn, the sequence of which has been selected stochastically. The energy beam travels to the first stopping point P1 determined in this way at time t and dwells at it for a defined stopping time Δt1. Subsequently, the energy beam is deflected at higher, preferably maximum, velocity to position P2 and held there for a defined holding time Δt2. In one heating pass, this procedure is applied to all holding points P1 to Pn at least once.

Typically, the holding points P1 to Pn are placed in a regular grid 41 with grid spacings 42 in the heating area 30a so that it is completely filled. The grid spacings between a breakpoint Pi from the set {P1, P2, . . . , Pn} and its direct neighbours can be set as desired. Preferably, the grid spacings are in the range of the diameter of the focused beam, for normally distributed beam intensity between 0.5 and 2 of the standard deviation.

The beam parameters during the preheating step are selected so that the energy beam heats the powder bed locally, preferably sintering it, without transferring the material to the molten phase. Preferably, the energy beam is used defocused during the preheating step. In this case, if the energy beam is an electron beam, the beam current is preferably 20 to 100 mA and the hold time of each hold point is 1 to 100 μs, depending on the powdery material, the beam diameter and the accelerating voltage. In another embodiment, the beam current is 300 mA and the holding times Δt1 to Δtn vary between 0.1 and 10 ps, with a defocused beam typically used for heating.

Heating area, point holding times and beam parameters can be changed from layer to layer of the additively manufactured workpiece.

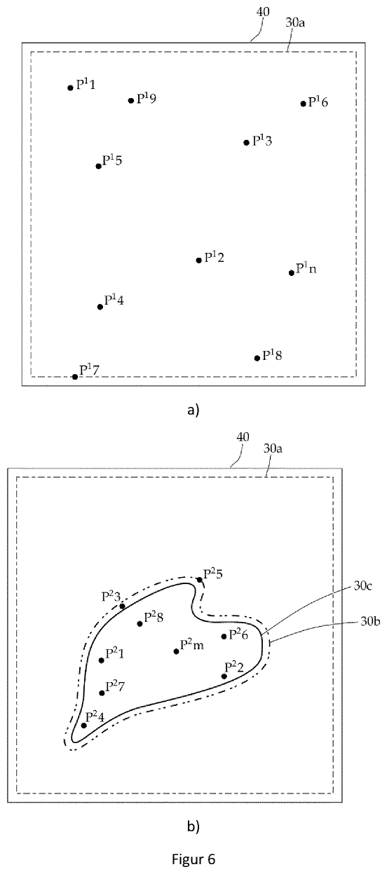

FIG. 5 shows an embodiment of a stochastic spot irradiation on an area 30c to be melted with one energy beam, which preferably lies completely in the deflection field 40 of the one energy beam. This melting area 30c can be taken, for example, from the cutting data of a 3D workpiece to be manufactured additively. In the melting area 30c, the energy beam is guided over a defined number of holding points P1 to Pn in such a way that the powder bed is locally melted at least briefly at these points. Between the stopping points, the energy beam is deflected at high, preferably maximum, speed. Preferably, the energy beam is focused during the melting step. The holding points can be assigned any positions within the melting area 30c, preferably they are located on a grid 41. For a complete melting of the melting area 30c, the grid 41 is exemplarily designed to be regular and has a constant grid width 42, which is 0.5 to 2 standard deviations for normally distributed beam intensity.

In one embodiment of the melting step, the positions of the stopping points P1 to Pn are controlled exactly once in a stochastically predetermined sequence, with the energy beam dwelling at the respective stopping points for a defined dwell time Δt1 to Δtn. Preferably, the beam current of an electron beam is between 5 mA to 50 mA with a variable dwell time of 1 to 100 μs.

In a further embodiment according to the invention, the positions of the dwell points P1 to Pn are controlled at least once in a stochastically predetermined sequence, preferably with lower beam currents and dwell times as in the case of a single run-down, the beam currents and/or the dwell times decreasing with an increasing number of repetitions.

The melting area, point holding times and beam parameters can be changed from layer to layer of the additively manufactured workpiece.

FIG. 6 shows an embodiment of a multi-stage preheating process with stochastic spot irradiation.

As an example, the preheating process consists of two preheating steps which are carried out immediately one after the other. In the first preheating step, as shown in FIG. 6a, a first heating area 30a is heated and in the second preheating step, as shown in FIG. 6b, a second heating area 30b is heated. The second heating area 30b is sensibly located completely in the first heating area 30a.

In one embodiment, the first heating area 30a spans the entire deflection field 40 of the one energy beam. The second heating area 30b takes into account the 3D geometry of the workpiece to be additively manufactured and is preferably larger by a defined distance than the workpiece cross section 30c of the active layer to be melted.

The energy is introduced by an energy beam which is guided within the first heating area via the holding points P11 to P1n and within the second heating area via the holding points P21 to P2m, the sequences of the holding points being stochastically predetermined.

In one embodiment, the preheating of the first heating area 30a preferably occurs with high power input with a strongly defocused beam and the heating of the second heating area 30b preferably occurs with lower power input with a weakly defocused beam.

In further embodiments of the invention, the at least two preheating steps alternate with at least one process step not primarily used for preheating.

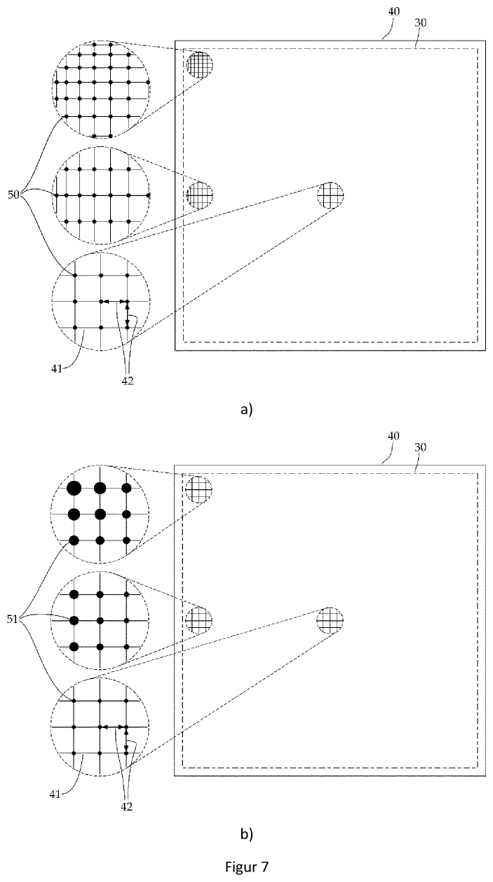

FIG. 7 shows an example of preheating with stochastic spot irradiation with control to achieve a homogeneous energy field. Irradiating an area 30 with constant beam parameters over the entire area and a uniform grid results in an inhomogeneous temperature field within the heating area due to energy dissipation into colder outer areas. Temperature differences between regions near the center and near the edges of the heating area typically amount to a few 10 to a few 100 K.

FIG. 7a shows an embodiment according to the invention in which the grid spacing 42 of the grid 41 determining the position of the breakpoints is designed to be indirectly proportional to the temperature gradient. The breakpoints are controlled in stochastic sequence. The density of the grid 41 defines the local power input and thus the temperature field via the number of breakpoints per unit area.

FIG. 7b sketches a further embodiment in which the local power input is determined by the beam parameters. Here, the grid 41 has a constant grid width 42. Stop points in regions of lower temperature exhibit at least one of the following changes relative to stop points in regions of high temperature: (a) higher beam power, (b) longer stop time, (c) higher number of repetitions.

In a further embodiment, the above embodiments may be overlaid with an energy model such that overall regional dwell times result in additional control of the temperature field.

In a further embodiment, the irradiation sequences outlined in FIGS. 7a and 7b can be applied in the melting step with adapted beam parameters.

The steps described above are repeated layer by layer until the 3D structure is completed.

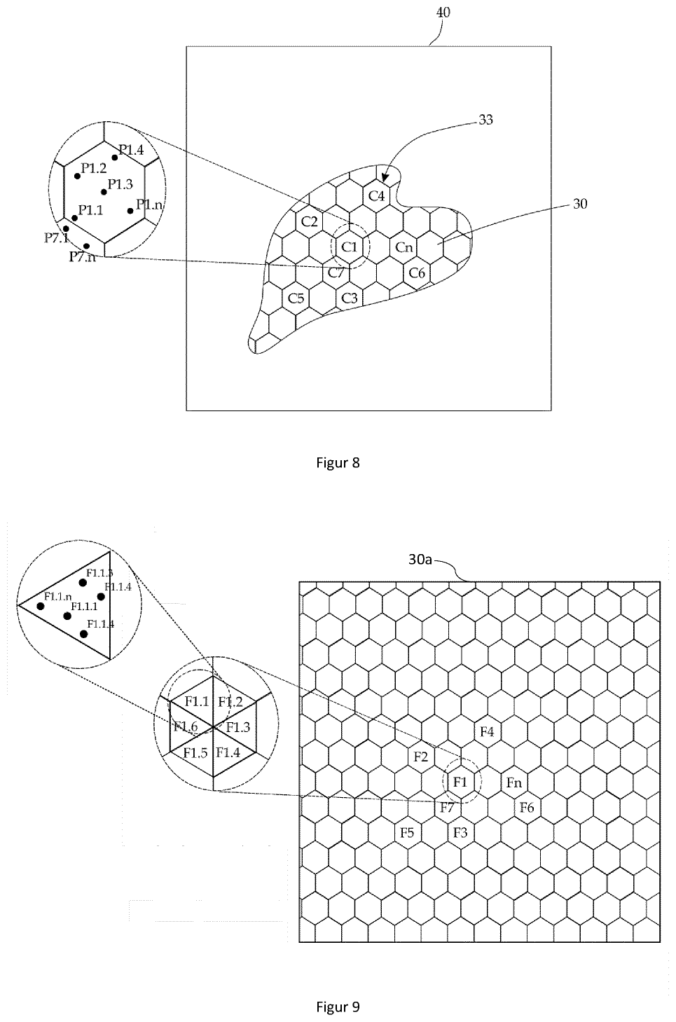

FIG. 8 shows another embodiment according to the invention with a subdivision of the melting area 30 into cells 3. The subdivision can consist of similar hexagons as shown in FIG. 8. However, the melting area may also be subdivided into other geometric shapes that differ from each other (e.g., squares, circles, etc.), the size of which may also differ from each other.

In a first step, the melting area 30 is divided into cells 3. Each cell is completely filled with dots, which are irradiated during the process. The order in which the cells are irradiated can be the same as the order of the points to be irradiated randomly, pseudo-randomly, quasi-randomly or according to a specific order. As soon as each point P1.n of the first cell C1 has been irradiated, the beam jumps to the next cell Cn and irradiates all points to be irradiated there.

In another embodiment, the process may be designed such that only a certain proportion of the points in one cell are irradiated, the beam jumps to one or more other cells, and then returns to the first cell and irradiates the remaining points.

This procedure is repeated until all dots in all cells have been exposed.

FIG. 9 shows a method according to the invention that is particularly suitable for preheating the powder layer.

The entire heating area 30a is divided into cells F1-Fn. These cells F1-Fn are then subdivided into sub-cells. Each cell is completely filled with points Fn.n.1-Fn.n.n, which are irradiated during the process. During preheating and/or postheating, the beam irradiates the points Fn.n.1-Fn.n.n randomly or according to a certain order. After all points of a sub-cell Fn.n.n have been irradiated, the beam jumps to the next sub-cell Fn.n.n+1. All sub-cells of a cell F1-n can be irradiated one after the other or only all nth sub-cells are irradiated. The order of the cells and/or sub-cells can be random or according to an order.

### REFERENCE NUMERALS

P, P1, P2 . . . Pn Points to be irradiated
10 Electron beam system
11 Process chamber
12 Electron beam generator
13 Electron beam
14 Magnetic optics unit
15 Lifting table
16 Powder application unit
17 Base plate
20 Powder bed
21 Top powder layer
22 Workpiece
23 Control unit
24 Signal transmission lines
30 Irradiation area
30a Heating area
30b contour-matched heating area
30c melting area
31 linear paths
32 path between two points to be irradiated
40 deflection field
41 grid
42 grid spacing
50 Point to be irradiated with constant power input
51 Point to be irradiated with variable power input

1. Method for processing a powdery material for additive manufacturing of a workpiece (22) comprising the following steps:
a) Providing
a device (15) for receiving a powder bed (20) of the powdery material to be processed, and
a beam generator (12) adapted to direct an energy beam (13) to laterally different locations of the powder bed (20);
b) Layering the powdery material into the powder bed (20);
c) Irradiating an area (30; 30a; 30b; 30c) in the powder bed (20) with the energy beam (13), the area (30; 30a; 30b; 30c) being composed of a plurality n of points P1 . . . Pn arranged in two dimensions, which are irradiated successively;
characterized in that
d) at least once during the irradiation of the area (30; 30a; 30b; 30c), two successively irradiated points Pi, Pi+1 are spaced apart from one another in such a way that, in each of the two dimensions, at least one other point P1 . . . Pi−1, Pi+2 . . . Pn to be irradiated is located between the two successively irradiated points Pi, Pi+1.

2. The method according to claim 1, characterized in that at least 10%, preferably at least 30%, of the distances of two successively irradiated points Pi, Pi+1 differ from those distances of the subsequently successively irradiated points Pi+1, Pi+2 from each other.

3. The method according to any one of the preceding claims, characterized in that the selection of the next point Pi+1 to be irradiated in step c) is random, pseudo-random or quasi-random.

4. The method according to any one of the preceding claims, characterized in that step c) is part of a heating step in which an energy input introduced into the powder bed by the energy beam is insufficient to completely melt the powdery material.

5. The method according to claim 4, characterized in that the heating step comprises a 2-stage heating process.

6. The method according to any one of the preceding claims, characterized in that the step c) generates a molten bath, preferably the generated molten bath is not guided.

7. The method according to any one of the preceding claims, wherein the selection of the next point to be irradiated is random, pseudo-random or quasi-random, as well as dependent on the energy input, in particular an energy balance or a heat balance.

8. The method according to one of the preceding claims, characterized in that
a) the sequence of the points P1 . . . Pn to be irradiated is determined before the construction of a workpiece (22)
or
b) the sequence of points P1 . . . Pn to be irradiated is determined layer by layer during the construction of a workpiece (22)
or
c) the calculation of the next point P1 . . . Pn to be irradiated is performed while or after a current point Pi is or has been irradiated.

9. The method according to one of the preceding claims, characterized in that the path between two points Pi, Pi+1 to be irradiated is exposed.

10. An apparatus for processing a powdery material for additive manufacturing of a workpiece (22), comprising
a) a device (15) for receiving a powder bed (20) of the powdery material to be processed, and
b) a beam generator (12) which is set up to direct an energy beam (13) to laterally different locations of the powder bed (20);
characterized in that
c) the apparatus is adapted to carry out the method according to any one of claims 1 to 9.
